(19) United States
(12) Patent Application Publication
(10) Pub. No.: US 2025/0068842 A1
(43) Pub. Date: Feb. 27, 2025

(54) DATA EXTRACTION USING DIFFERENT TRAINED MODELS

(71) Applicant: SAP SE, Walldorf (DE)

(72) Inventors: Shruthi ANNAPPA, Bangalore (IN); Vidhya K. PAI, Bangalore (IN); Raghavendra R. PRABHU, Bangalore (IN)

(21) Appl. No.: 18/455,072

(22) Filed: Aug. 24, 2023

(51) Int. Cl. G06F 40/279; G06F 16/93; G06F 40/40

(52) U.S. Cl. CPC G06F 40/279; G06F 16/93; G06F 40/40

(57) ABSTRACT

Systems and methods reception of an object for entity extraction, identification of an extraction schema instance associated with the object, determination of a first extraction field and a first model associated with the first extraction field based on the extraction schema instance, generation of an input payload according to an input format of the first model, reception of a first value of the first extraction field output by the first model, determination of a second extraction field and a second model associated with the second extraction field, input of the object to the second model to output a second value of the second extraction field, and reception of the second value.

### BACKGROUND

Modern enterprise computing systems store vast amounts of data for their respective enterprises. Users may operate software applications to access this stored data in order to facilitate enterprise operations. For example, software applications may provide automated workflow execution or data forecasting based on stored data. Such operations are increasingly assisted by trained neural networks, or machine learning models.

A machine learning model may be trained to infer a value of a target (e.g., delivery date) based on a set of inputs (e.g., fields of a specific sales order). The training may be based on historical data (e.g., a large number of sales orders and their respective delivery dates). Training causes a machine learning model to learn patterns in the historical data which allow it to infer a target value (e.g., a delivery date) based on new input data (e.g., a new sales order).

Some machine learning models excel at entity recognition. Such models may be trained to recognize particular entities within text, and therefore may be used to automate the processing of documents. For example, a model may recognize and extract an address, an item ID and a quantity from a purchase order and use these values to automatically populate corresponding fields of an invoice.

A typical enterprise uses many different types of documents, such as but not limited to invoices, purchase orders, contracts, and delivery instructions. Moreover, documents of the same type may exhibit different formatting. Some documents are highly unstructured and do not follow any standardized format. It is difficult to train a model which can accurately recognize entities from all possible document types and formats.

Large sets of training data are typically needed to effectively train a machine learning model. In the case of an entity extraction task, the training data consists of a large number of documents which have been annotated to identify the entities therein. Annotating these documents is a manual undertaking which is extremely time and resource-consuming.

Systems are desired to efficiently extract entities from documents of varied types and formats. Also desired are systems to facilitate annotation of machine learning training data.

### BRIEF DESCRIPTION OF THE DRAWINGS

FIG. 1 is a block diagram of an architecture to extract field values from a document using multiple machine learning models according to some embodiments.

FIG. 2 is a flow diagram of a process to extract field values from a document using multiple machine learning models according to some embodiments.

FIG. 3 illustrates an instance of an extraction schema according to some embodiments.

FIG. 4 is a user interface of an extraction schema management to configure a machine learning model destination according to some embodiments.

FIG. 5 is a flow diagram of a process to extract field values from a document using multiple machine learning models according to some embodiments.

FIG. 6 illustrates an instance of an extraction schema according to some embodiments.

FIG. 7 is a block diagram of an architecture to extract field values from documents using multiple machine learning models according to some embodiments.

FIG. 8 is a block diagram of an architecture to train a model to extract field values from a document using training data including extracted field values according to some embodiments.

FIG. 9 is a block diagram of a hardware system providing training and inference management according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Briefly, some embodiments allow the definition of specific models for use in extracting specific fields from a document. For example, an instance of an extraction schema may specify field to be extracted and a model to be used for the extraction of each field. The model may be a pre-trained model integrated into an application or an external publicly-available model such as a Large Language Model (e.g., GPT3, GPT4, Bloom)

Advantageously, a different extraction schema instance may be associated with each of several document types. Moreover, different organizations may use different extraction schema instances, even in the case of identical document types.

Field values extracted from a document using extraction schema instances according to some embodiments may be used as ground truth values of a training data instance associated with the document. Embodiments may therefore facilitate the generation of training data instances. These training data instances may then be used to train a model to extract values of the fields documents to be used as training data.

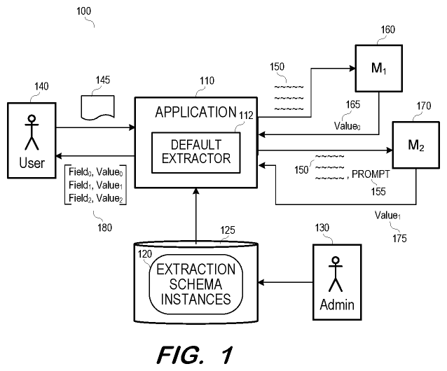

FIG. 1 is a block diagram of an architecture of system 100 according to some embodiments. The illustrated elements of system 100 may be implemented using any suitable combination of computing hardware and/or software that is or becomes known. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service). Such implementations apportion computing resources elastically according to demand, need, price, and/or any other metric.

Application 110 may be executed by an application server (not shown) which may comprise one or more standalone servers and/or virtual machines. Application 110 may provide any suitable functionality to users. Application 110 may comprise a component of an enterprise software suite and may comprise an on-premise application and/or one or more Web services.

Application 110 includes default extractor 112. Default extractor 112 may comprise a pretrained machine learning model, a RegEx-based processor, or any other suitable component which may be used by application 110 to extract values of one or more fields from a document. For example, application 110 may pass document text to default extractor 112 and receive values for each of one or more fields in return.

Default extractor 112 may be separate from application 110 and may or may not execute in a same application server as application 110. Default extractor 112 may be provided by a provider of application 110 and accessible only to users of application 110. Some embodiments include two or more selectable default extractors as will be described below.

Application 110 uses extraction schema instances 120 to determine extraction models for extracting various document fields. An extraction schema instance 120 may specify, for a given document type and/or user, fields to be extracted and the respective extraction model to be used to extract each field. In other words, an extraction schema instance 120 may specify the use of two or more models to extract fields from a single document. Extraction schema instances 120 conform to an extraction schema, examples of which are provided below. Instances 120 may be generated based on commands from administrator 130.

Data store 125 may comprise any standalone or distributed storage system that is or becomes known. Data store 125 may store a database or other data used by application 110. Application 110 may create, read, update and delete data of data store 125 based on a data schema consisting of semantic objects as is known in the art. For instance, the data may comprise relational database tables and views whose columns conform to a data schema defined by metadata also stored in data store 125.

As shown, user 140 (after appropriate authentication and authorization) interacts with application 110 to request extraction of fields from document 145. Document 145 may conform to any known format, including but not limited to text formats, image formats and portable document formats. Although FIG. 1 illustrates transmission of document 145 from user 140 to application 110, it should be understood that user 140 may simply identify document 145, which is then retrieved by application 110 from elsewhere (e.g., data store 125).

Application 110 identifies an extraction schema instance 120 for use in extracting the fields from the document. Identification of an instance 120 may be based on document type, user identity, fields to be extracted, user selection, and/or any other suitable parameter. In this regard, each instance 120 may be associated with one or more document types, user identities, and extraction fields to facilitate this identification.

Based on the identified instance, application 110 determines fields to be extracted from document 145 and a model to be used to extract each field. For example, it will be assumed that the identified instance 120 specifies three fields (i.e., Field₀, Field₁, Field₂), and that each field is to be extracted using a different model (i.e., default extractor 112, model M₁ 160, and model M₂ 170).

The extractors/models described herein may comprise any type of machine learning-compatible network, algorithm, decision tree, Large Language Model, etc., that is or becomes known. The extractors/models may be designed to perform entity recognition. One or more of the extractors/models may comprise a network of nodes which receive input, change internal state according to that input, and produce output depending on the input and internal state. The output of certain nodes is connected to the input of other nodes to form a directed and weighted graph. The weights are modified during training using learning algorithms, examples of which will be described below.

Application 110 converts document 145 to text 150, if needed, and transmits text 150 to default extractor 112, to model M₁ 160, and to model M₂ 170. Model M₂ 170 may comprise a Large Language Model and therefore application 110 transmits prompt 155 along with text 150 to model M₂ 170.

For each model, the identified instance 120 may specify values of input payload parameters including formatting parameters and prompt parameters, and connection parameters including URL and authentication parameters. Application 110 may use the input payload parameter values to generate an input payload specific to each model based on the corresponding input payload parameter values and may transmit the input payload to each model using the corresponding connection parameter values.

Model M₁ 160 and model M₂ 170 return values 165 and 175 for their respective fields to application 110. Application 110 may then format response 180 based on values 165, 175 and a value returned by extractor 112 and return response 180 to user 140.

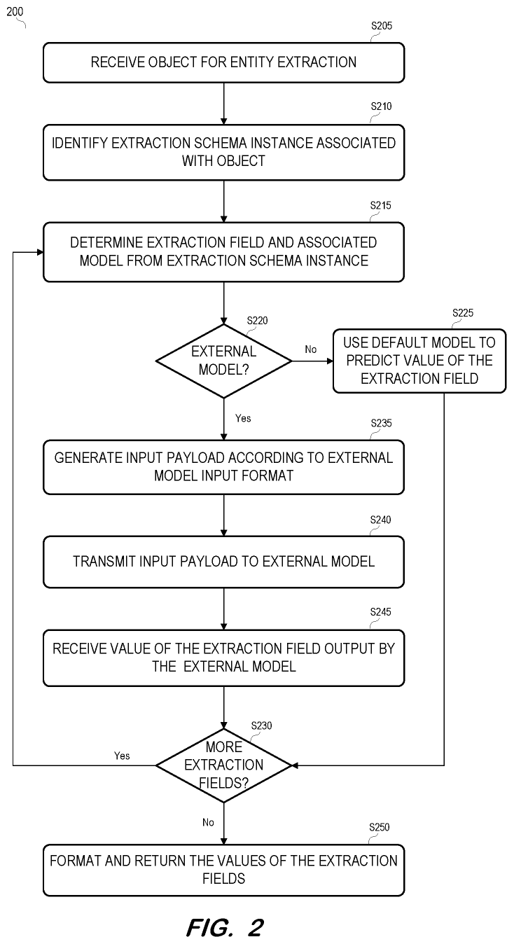

FIG. 2 comprises a flow diagram of process to extract field values from a document using multiple machine learning models according to some embodiments. Process 200 will be described with respect to the elements of system 100, but embodiments are not limited thereto.

Process 200 and all other processes mentioned herein may be embodied in processor-executable program code read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S205, an object for entity extraction is received. The object may comprise a document or any other representation of text. As described with respect to document 145, the object may comprise an image, a text document, or otherwise-formatted object. The object may be received at S205 from a local or remote database, from a user requesting entity extraction, or from any other suitable source.

At S210, an extraction schema instance associated with the object is identified. The instance may be identified based on object type (e.g., Sales Order, Invoice), user identity, fields to be extracted, user selection, and/or any other suitable parameter. The instance may be identified from a plurality of stored instances of an extraction schema object, where each stored instance may be associated with one or more document types, user identities, and extraction fields.

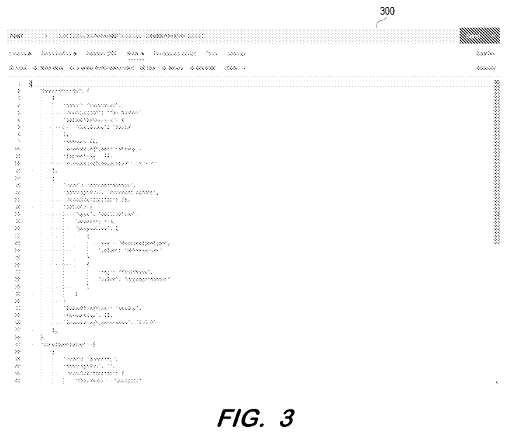

FIG. 3 illustrates an instance 300 of an extraction schema according to some embodiments. Embodiments are not limited to the content and/or format of instance 300.

As shown, instance 300 associates each field to be extracted with a name, a description and a defaultExtractor. If the defaultExtractor is not NULL, instance 300 specifies a fieldName (e.g., “taxId”) to pass to a defaultExtractor. The identity of the defaultExtractor is known to the application using instance 300 and may be managed thereby.

If the defaultExtractor associated with a field is not NULL, it is assumed that the field is to be extracted using an external model. Instance 300 associates such field with values of setup parameters including a type (i.e., “destination”=external model), a destinationType (e.g., “GPTv3-Azure”) and a fieldName. The destinationType may be associated with information usable to access the associated external model and to generate an input payload suitable for the associated external model.

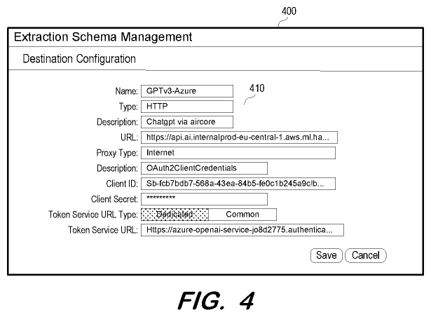

FIG. 4 illustrates extraction schema management user interface 400 according to some embodiments. A computing system operated by an administrator may execute a Web browser to access user interface 400. An administrator may use interface 400 to specify information usable to access an external model of a particular destinationType and to generate an input payload suitable for the external model. In particular, fields 410 of interface 400 specify a name, type and description of the destinationType, as well as connection and authorization information which can be used to transmit a payload to and receive a response from the associated model.

Returning to process 200, an extraction field and associated model are determined at S215 based on the identified extraction schema instance. With respect to the example of instance 300, the extraction field “taxId” may be initially determined at S215. As noted, this field is associated with a defaultExtractor.

At S220, it is determined whether the associated model is an external model. If not, as in the present example, flow proceeds to S225. The default model is used at S225 to predict the value of the determined extraction field. For example, the object received at S205 is converted to text and the text is submitted to the default model at S225. The name of the extraction field may also be submitted at to the default model at S225. A predicted value of the extraction field is then returned, and flow continues to S230.

At S230, it is determined whether the extraction schema instance specifies additional extraction fields. If so, flow returns to S215 to determine another extraction field and its associated model from the extraction schema instance. Continuing the present example, the extraction field “documentNumber” and the associated model “GPTv3-Azure” are next determined from instance 300 at S215.

Since the model is an external model, flow proceeds from S220 to S235. At S235, an input payload is generated according to an input payload format associated with the external model. The input payload format may specify a prompt to be transmitted to the external model along with the text of the object in order to instruct the external model to extract the particular extraction field. The input payload is transmitted to the external model at S240. The transmission may utilize the connection parameter values associated with the destinationType of the external model.

Next, at S245, a value of the extraction field output by the external model is returned. Flow proceeds to S230 and continues as described above to receive values corresponding to each extraction field specified in the extraction schema instance. It should be noted that the extraction schema instance may specify two or more different external models (i.e., each configured as a separate destinationType) and corresponding extraction fields, and more than one extraction field may be associated with a single external or default extraction model. Moreover, although process 200 describes sequential extraction of each extraction field of an extraction schema instance, two or more field extractions may be executed in parallel.

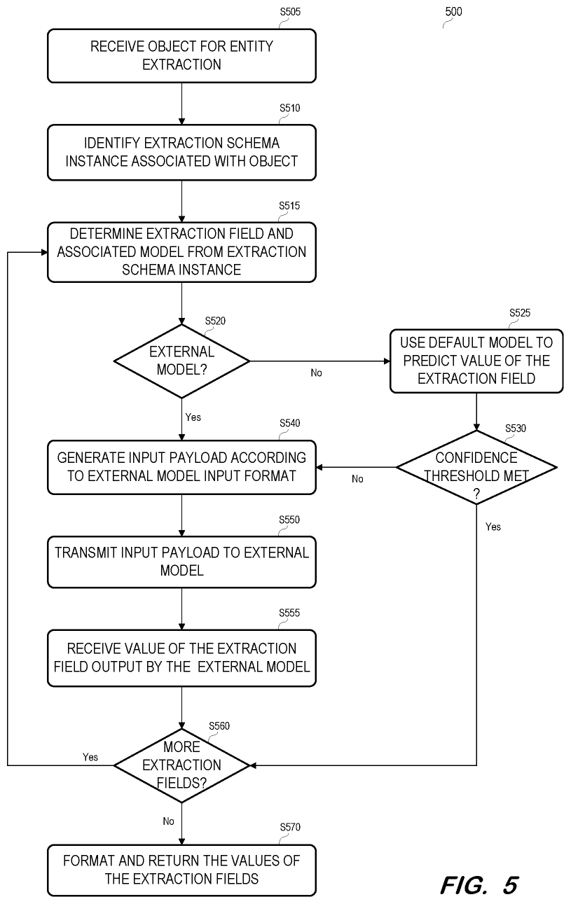

FIG. 5 is a flow diagram of process 500 according to some embodiments. Process 500 is identical to process 200 except for the presence of accuracy threshold determination S530.

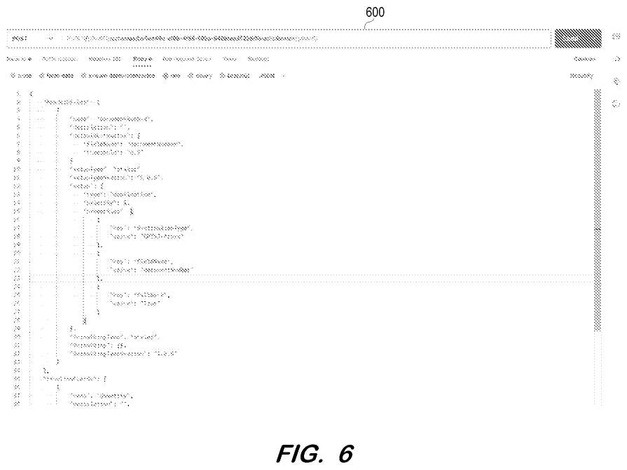

Process 500 may be executed in a case of an execution schema instance which specifies a threshold confidence score and a fallback model for one or more extraction fields. Instance 600 of FIG. 6, in this regard, specified a confidence threshold of “0.7” for the extraction field “documentNumber”. Also associated with “documentNumber” is destinationType “GPTv3-Azure”.

Assuming that instance 600 is identified at S510, the extraction field “documentNumber” and the default model are determined at S515. Since the default model is not an external model, the default model is used at S525 to predict the value of the extraction field as described above. S525 returns the value as well as a confidence score, as is known in the art.

Next, at S530, it is determined whether the returned confidence score exceeds the threshold associated with the extraction field (e.g., 0.7) by instance 600. If so, flow proceeds to S560 and continues as described above with respect to process 200. If not, flow proceeds to S540. At S540, an input payload is generated according to the input format configured for the destinationType (i.e., “GPTv3-Azure’) associated with the extraction field in instance 600. The input payload is then transmitted to this external model at S550, and flow continues as described above.

Accordingly, process 500 and instances such as instance 600 provide a “fallback” model for extracting a value of a field in a case that an output of the default model is not suitable. Such embodiments may be advantageous in cases where it is more desirable to use a default model than an external model, for example due to associated cost and/or latency.

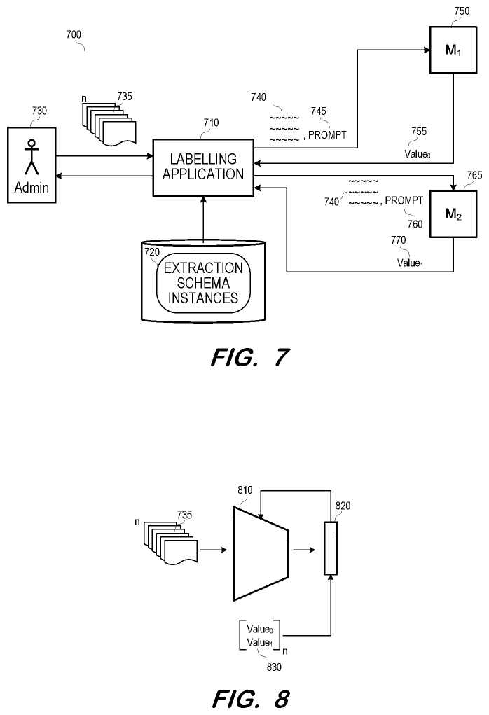

FIG. 7 is a block diagram of architecture 700 according to some embodiments. Architecture 700 may operate to facilitate labelling of training data instances as will be described below.

Labelling application 710 uses extraction schema instances 720 to generate labels for training data instances. For example, administrator 730 accesses labelling application 710 and submits n documents 735 thereto. Documents 735 may comprise any document type or format. Administrator 730 also specifies fields for which values are to be extracted from each of documents 735.

Labelling application 710 identifies an extraction schema instance 720 based on a selection of administrator 730, the fields specified by administrator 730, the identity of administrator 730 and/or any other criteria. Using the identified instance 720, labelling application 710 identifies a model for each extraction field. For example, model M₁ 750 may be identified for a first extraction field and model M₂ 765 may be identified for a second extraction field.

Labelling application 710 converts each document 735 to text 740 and generates an input payload for each of model M₁ 750 and model M₂ 765 based on parameter values of the instance 720. The respective input payloads include prompts 745 and 760 and are transmitted to model M₁ 750 and model M₂ 765 based on the connection parameter values of the instance 720.

Values 755 and 770 are then returned to labelling application 710. Administrator 730 may then choose to associate the values returned for each document 735 with the document, resulting in training data instances which each consist of a document and associated extracted values. If one or more values returned for a document 735 appear incorrect to administrator 730, administrator 730 may operate application 710 to change the value(s). These training data instances may then be used to train a model to extract the corresponding extraction fields.

FIG. 8 illustrates training of model 810 using training data instances generated according to some embodiments. The training data instances include n documents 735 and, for each document 735, a corresponding ground truth vector of labels 830 including two ground truth values.

In one example of training, batches of documents 735 are input to model 810, which outputs a value for each extraction field for each input document 735. Loss layer 820 compares the output values to the ground truth labels 830 associated with each of the input documents 735 to determine a total loss. The loss is back-propagated to model 810, which is modified based thereon as is known in the art. Training continues in this manner until satisfaction of a given performance target or a timeout situation.

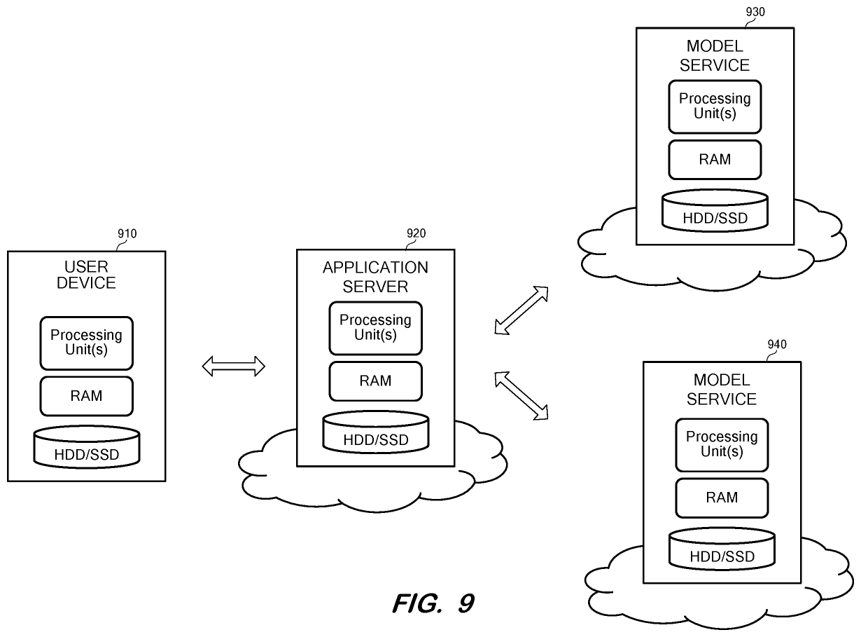

FIG. 9 illustrates a cloud-based database deployment according to some embodiments. The illustrated components may comprise cloud-based compute resources residing in one or more public clouds providing self-service and immediate provisioning, autoscaling, security, compliance and identity management features.

User device 910 may be operated by a user to request field extraction from an application executing on application server 920. Application server 920 may respond to such requests by accessing external models provided by service 930 and/or service 940 as described above. Server 920, service 930 and service 940 may comprise servers or virtual machines of a Kubernetes cluster.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable program code; and
a processing unit to execute the processor-executable program code to cause the system to:
receive an object on which to perform entity extraction;
from a plurality of extraction schema instances, identify an extraction schema instance associated with the object;
determine a first extraction field and a first model associated with the first extraction field based on the extraction schema instance;
generate an input payload according to an input format of the first model;
transmit the input payload to the first model;
receive a first value of the first extraction field output by the first model;
determine a second extraction field and a second model associated with the second extraction field based on the extraction schema instance;
input the object to the second model to output a second value of the second extraction field; and
receive the second value.

2. A system according to claim 1, wherein the first model is a large language model, and the input payload includes a prompt and the object.

3. A system according to claim 2, wherein the second model is a pre-trained model.

4. A system according to claim 1, the processing unit to execute the processor-executable program code to cause the system to:
determine a confidence score associated with the second value;
determine a threshold associated with the second extraction field based on the instance;
determine if the confidence score is greater than the threshold; and
if the confidence score is not greater than the threshold:
determine a third model associated with the second extraction field based on the extraction schema instance;
generate a second input payload according to an input format of the third model;
transmit the second input payload to the third model;
receive a third value of the second extraction field output by the third model; and
return the first value and the third value.

5. A system according to claim 4, the processing unit to execute the processor-executable program code to cause the system to:
receive a second object on which to perform entity extraction;
from a plurality of extraction schema instances, identify the extraction schema instance as associated with the second object;
determine the first extraction field and the first model associated with the first extraction field based on the extraction schema instance;
generate a third input payload according to the input format of the first model;
transmit the third input payload to the first model;
receive a fourth value of the first extraction field output by the first model;
determine the second extraction field and the second model associated with the second extraction field based on the extraction schema instance;
input the second object to the second model to output a fifth value of the second extraction field;
determine a second confidence score associated with the fifth value;
determine that the second confidence score is greater than the threshold; and
based on the determination that the second confidence score is greater than the threshold, return the fourth value and the fifth value.

6. A system according to claim 1, the processing unit to execute the processor-executable program code to cause the system to:
receive a second object on which to perform entity extraction;
from a plurality of extraction schema instances, identify a second extraction schema instance associated with the second object;
determine the first extraction field and the first model associated with the first extraction field based on the second extraction schema instance;
generate a second input payload according to the input format of the first model;
transmit the second input payload to the first model;
receive a third value of the first extraction field output by the first model;
determine a third extraction field and a third model associated with the third extraction field based on the second extraction schema instance;
generate a third input payload according to the input format of the third model;
transmit the third input payload to the third model; and
receive a fourth value of the third extraction field output by the third model.

7. A system according to claim 1, the processing unit to execute the processor-executable program code to cause the system to:
receive a second object on which to perform entity extraction;
from a plurality of extraction schema instances, identify a second extraction schema instance associated with the second object;
determine the first extraction field and the first model associated with the first extraction field based on the second extraction schema instance;
generate a second input payload according to the input format of the first model;
transmit the second input payload to the first model;
receive a third value of the first extraction field output by the first model;
determine the second extraction field and a third model associated with the second extraction field based on the second extraction schema instance;
generate a third input payload according to the input format of the third model;
transmit the third input payload to the third model; and
receive a fourth value of the second extraction field output by the third model.

8. A method comprising:
receiving a document;
from a plurality of extraction schema instances, identifying an extraction schema instance based on a type of the document;
determining a first extraction field and a first model associated with the first extraction field based on the extraction schema instance;
generating an input payload including text of the document and according to an input format of the first model;
transmitting the input payload to the first model;
receiving a first value of the first extraction field output by the first model;
determining a second extraction field and a second model associated with the second extraction field based on the extraction schema instance;
inputting the text of the document to the second model to output a second value of the second extraction field; and
receiving the second value.

9. A method according to claim 8, wherein the first model is a large language model, and the input payload includes a prompt and the text of the document.

10. A method according to claim 9, wherein the second model is a pre-trained model.

11. A method according to claim 8, further comprising:
determining a confidence score associated with the second value;
determining a threshold associated with the second extraction field based on the instance;
determining if the confidence score is greater than the threshold; and
if the confidence score is not greater than the threshold:
determining a third model associated with the second extraction field based on the extraction schema instance;
generating a second input payload including the text and according to an input format of the third model;
transmitting the second input payload to the third model;
receiving a third value of the second extraction field output by the third model; and
returning the first value and the third value.

12. A method according to claim 11, further comprising:
receiving a second document;
generating a third input payload including text of the second document and according to the input format of the first model;
transmitting the third input payload to the first model;
receiving a fourth value of the first extraction field output by the first model;
inputting the text of the second document to the second model to output a fifth value of the second extraction field;
determining a second confidence score associated with the fifth value;
determining that the second confidence score is greater than the threshold; and
based on the determination that the second confidence score is greater than the threshold, returning the fourth value and the fifth value.

13. A method according to claim 8, further comprising:
receiving a second document;
identifying a second extraction schema instance associated with the second document;
determining the first extraction field and the first model associated with the first extraction field based on the second extraction schema instance;
generating a second input payload according to the input format of the first model;
transmitting the second input payload to the first model;
receiving a third value of the first extraction field output by the first model;
determining a third extraction field and a third model associated with the third extraction field based on the second extraction schema instance;
generating a third input payload according to the input format of the third model;
transmitting the third input payload to the third model; and
receiving a fourth value of the third extraction field output by the third model.

14. A method according to claim 8, further comprising:
receiving a second document;
identifying a second extraction schema instance associated with the second document;
determining the first extraction field and the first model associated with the first extraction field based on the second extraction schema instance;
generating a second input payload according to the input format of the first model;
transmitting the second input payload to the first model;
receiving a third value of the first extraction field output by the first model;
determining the second extraction field and a third model associated with the second extraction field based on the second extraction schema instance;
generating a third input payload according to the input format of the third model;
transmitting the third input payload to the third model; and
receiving a fourth value of the second extraction field output by the third model.

15. A non-transitory medium storing processor-executable program code executable by a processing unit of a computing system to cause the computing system to:
receive an object on which to perform entity extraction;
from a plurality of extraction schema instances, identify an extraction schema instance associated with the object;
determine a first extraction field and a first model associated with the first extraction field based on the extraction schema instance;
generate an input payload according to an input format of the first model;
transmit the input payload to the first model;
receive a first value of the first extraction field output by the first model;
determine a second extraction field and a second model associated with the second extraction field based on the extraction schema instance;
input the object to the second model to output a second value of the second extraction field; and
receive the second value.

16. A medium according to claim 15, wherein the first model is a large language model, and the input payload includes a prompt and the object.

17. A medium according to claim 15, the processor-executable program code executable by a processing unit of a computing system to cause the computing system to:
determine a confidence score associated with the second value;
determine a threshold associated with the second extraction field based on the instance;
determine if the confidence score is greater than the threshold; and
if the confidence score is not greater than the threshold:
determine a third model associated with the second extraction field based on the extraction schema instance;
generate a second input payload according to an input format of the third model;
transmit the second input payload to the third model;
receive a third value of the second extraction field output by the third model; and
return the first value and the third value.

18. A medium according to claim 17, the processor-executable program code executable by a processing unit of a computing system to cause the computing system to:
receive a second object on which to perform entity extraction;
from a plurality of extraction schema instances, identify the extraction schema instance as associated with the second object;
determine the first extraction field and the first model associated with the first extraction field based on the extraction schema instance;
generate a third input payload according to the input format of the first model;
transmit the third input payload to the first model;
receive a fourth value of the first extraction field output by the first model;
determine the second extraction field and the second model associated with the second extraction field based on the extraction schema instance;
input the second object to the second model to output a fifth value of the second extraction field;
determine a second confidence score associated with the fifth value;
determine that the second confidence score is greater than the threshold; and
based on the determination that the second confidence score is greater than the threshold, return the fourth value and the fifth value.

19. A medium according to claim 17, the processor-executable program code executable by a processing unit of a computing system to cause the computing system to:
receive a second object on which to perform entity extraction;
from a plurality of extraction schema instances, identify a second extraction schema instance associated with the second object;
determine the first extraction field and the first model associated with the first extraction field based on the second extraction schema instance;
generate a second input payload according to the input format of the first model;
transmit the second input payload to the first model;
receive a third value of the first extraction field output by the first model;
determine a third extraction field and a third model associated with the third extraction field based on the second extraction schema instance;
generate a third input payload according to the input format of the third model;
transmit the third input payload to the third model; and
receive a fourth value of the third extraction field output by the third model.

20. A medium according to claim 17, the processor-executable program code executable by a processing unit of a computing system to cause the computing system to:
receive a second object on which to perform entity extraction;
from a plurality of extraction schema instances, identify a second extraction schema instance associated with the second object;
determine the first extraction field and the first model associated with the first extraction field based on the second extraction schema instance;
generate a second input payload according to the input format of the first model;
transmit the second input payload to the first model;
receive a third value of the first extraction field output by the first model;
determine the second extraction field and a third model associated with the second extraction field based on the second extraction schema instance;
generate a third input payload according to the input format of the third model;
transmit the third input payload to the third model; and
receive a fourth value of the second extraction field output by the third model.
